(19) United States
(12) Patent Application Publication
(10) Pub. No.: US 2024/0181665 A1
(43) Pub. Date: Jun. 6, 2024

(54) AUTOMATIC APPAREL MACHINE

(71) Applicant: VIBRACOUSTIC CV AIR SPRING OTOMOTIV SANAYI VE TICARET ANONIM SIRKETI, Bursa (TR)

(72) Inventor: Ümit BIÇER, Bursa (TR)

(21) Appl. No.: 17/760,136

(22) PCT Filed: Mar. 19, 2021
(86) PCT No.: PCT/TR2021/050248

§ 371 Date: Aug. 4, 2022

(51) Int. Cl. B26D 5/00; B26D 3/00; B26D 7/06; B26F 1/38; B29D 22/02

(52) U.S. Cl. CPC B26D 5/007; B26D 3/003; B26D 7/06; B26F 1/3866; B29D 22/023

(57) ABSTRACT

An automatic apparel machine used in the manufacture of air suspension springs has two movable tables that move independently from each other on the rail system and where the raw material is placed. A movable winding mandrel moves up-down and forward-backward on the movable table by a servo motor. Automatic cutting bench grippers are positioned on the automatic rubber cutting bench perpendicular to the axis of the movable tables in the section where the movable winding mandrel is located so as to adjust the lengths of the cut raw material. An automatic rubber cutting bench cuts the raw material in the direction of the length and angles required for the finished product saved in the system.

### FIELD OF THE INVENTION

The present invention relates to an automatic apparel machine used in the manufacture of air suspension springs.

The present invention particularly relates to an automatic apparel machine that makes the raw material preparation process automatically by means of defined formulas, comprises 2 stands that move independently from each other instead of a belt system, wherein the positions of the raw materials located on these stands are controlled by a camera and the rotation of the mandrel is driven by a servo motor.

### STATE OF THE ART

The rubber air suspension systems for commercial and personal vehicles are increasingly used as spring damping components. The air suspension bellows consists of four layers as the following: inner rubber, first cord fabric, second cord fabric and outer rubber. Inner rubber and outer rubber have the same formula; however the only difference between them is their thickness. The semi-finished product is baked at a certain temperature, pressure and duration in the vulcanization press and its final form is given after the apparel process is completed. Machines that are called apparel machines or rubber wrapping machines are used for the apparel process.

During the production of the air suspension springs, the raw material is prepared manually by the operator. The operator shall cut the raw material to be used in production with the right length and at right angles manually. Afterwards, the raw materials used in the membrane production are positioned on the belt of the machine. Laser marking is performed so as to place the raw material in the correct position on the belt. After all materials are positioned, the process is initiated by the operator. The raw materials are wound sequentially on the rotating mandrel at the end of the moving belt. The operator starts the raw material preparation process required for the next step, during this winding process.

Slipping may occur in the moving belt on which the raw material is left in the machines currently used today. In case the belt slide to the right or left, the machine breaks down. Terminating the production until the breakdown is eliminated and the position of the belt is corrected causes labor loss. If the right or left sliding failure of the belt is not eliminated, deviation up to 2 degrees can occur in the final product winding angles. This problem may also cause emulgences in the technical characteristics of the finished product. On the other hand, the production duration increases and the production volume decrease, since the operator waits for the end of the winding operation so as to position a new product in the current machines. The waste ratio in the final product increases since its position is not controlled again after the product is positioned on the belt. Since the rotation drive of the mandrel in said machines is provided by friction to the moving belt system under the same, it may cause damage to the product to be wound by crumpling the same by the mandrel.

As a result, the requirement for a new automatic garment machine which eliminates the abovementioned problems and the insufficiency of the current solutions makes it necessary to make a development in the relevant technical field.

### BRIEF DESCRIPTION OF THE INVENTION

The present invention relates to an automatic garment machine used in the manufacture of air suspension springs which fulfills the abovementioned requirements, eliminates all disadvantages and brings some additional advantages.

The aim of the invention starting out from the state of the art is to eliminate the failures in product dimensions and to prevent inefficiencies due to the operator by making the preparation of raw materials by defined formulas automatically in the developed apparel machine.

The aim of the invention is to reduce control of the material sequences and positions and the operator competence required for production by means of the camera used in the apparel machine.

Another aim of the invention is to include the operating time of the operator in the operating time of the machine and to increase the production amount per unit time by allowing the operator to place the next raw material on the empty stand while the winding process continues, by means of at least two stands independent from each other used instead of the belt system in the apparel machine.

Another aim of the invention is to prevent false positioning the raw materials placed on the stand by controlling the positions of the same with the camera.

Another aim of the invention is to eliminate the angle difference problem that occur due to the sliding of the band to the right or left in existing applications and to standardize the final product by means of the rail system on which the stands operate.

Another aim of the invention is to prevent the weaving that may occur during product winding by means of rotating the mandrel with a servo motor in the apparel machine.

Another aim of the invention is to reduce the problem of presence of air between the layers by means of the pressure formed between the mandrel and the belt in the apparel machine.

Another aim of the invention is to facilitate the winding of the products by means of the heater located in the winding mandrel.

Another aim of the invention is to facilitate the removal of rubber from the mandrel by means of the air connection that is added in the winding mandrel and provides to blow air after the winding process is completed.

The structural and characteristic features of the present invention will be understood clearly by the following drawings and the detailed description made with reference to these drawings and therefore the evaluation shall be made by taking these figures and the detailed description into consideration.

### BRIEF DESCRIPTION OF DRAWINGS

In order to understand the advantages of the present invention with its structure and additional elements, it shall be evaluated with the following defined figures.

FIG. 1 is a schematic general view of the apparel machine,

FIG. 2 is a schematic general view of the apparel machine from a different angle,

FIG. 3 is a schematic general view of the moving winding mandrel mounted on the apparel machine,

FIG. 4 is a schematic general view of the movable table mounted on the apparel machine,

FIG. 5 is a schematic general view of the automatic cutting table mounted on the apparel machine,

FIG. 6 is a top schematic general view of the apparel machine.

### REFERENCE NUMBERS

10. Apparel machine
11. Movable table
12. Camera
13. Automatic rubber cutting bench
14. Movable winding mandrel
15. Automatic cutting bench grippers
16. Alignment lasers
17. Rail system

### DETAILED DESCRIPTION OF THE INVENTION

In this detailed description, the inventive an automatic apparel machine (10) used in the manufacture of air suspension springs is described only for clarifying the subject matter in a manner such that no limiting effect is created.

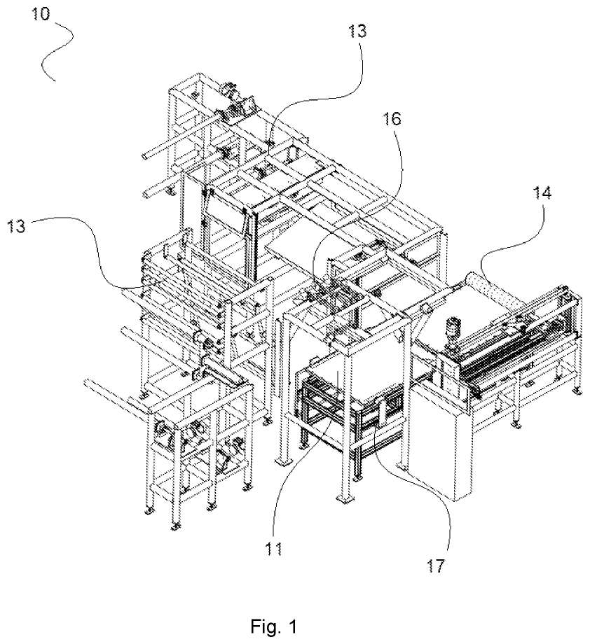

The angle and length settings have been defined on the system in the apparel machine (10) shown in FIG. 1, and the raw material preparation process is performed automatically by means of defined formulas so as to eliminate failures in the product dimensions. There are two movable tables (11) that move independently from each other, allow the operator to position raw materials on the next moving table (11) while the winding process continues, instead of the belt system used in the existing applications in said apparel machine (10). The amount of product produced per unit time is increased and the operator working time is included in the operating time of the machine by means of these movable tables (11). The positions of the raw materials located in said movable tables (11) are controlled by means of a camera (12). Another characteristic of said apparel machine (10) is that; the rotation drive of a movable winding mandrel (14) is performed by means of a servo motor so as to prevent crumpling that occur during product winding. The inventive automatic apparel machine (10) mainly comprises the following; two movable tables (11) that move independently from each other on a rail system (17) and where the raw material is placed; the movable winding mandrel (14) moving up-down and forward-backward on the movable table (11) by means of servo motor; automatic cutting bench grippers (15) that is positioned on an automatic rubber cutting bench (13) perpendicular to the axis of the movable tables (11) in the section where the movable winding mandrel (14) is located so as to adjust the lengths of the cut raw material; the automatic rubber cutting bench (13) that cuts the raw material in the direction of the length and angles required for the finished product recorded in the system.

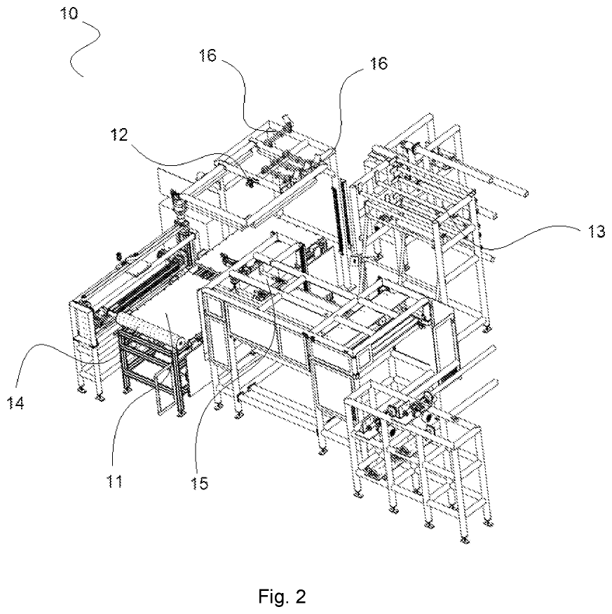

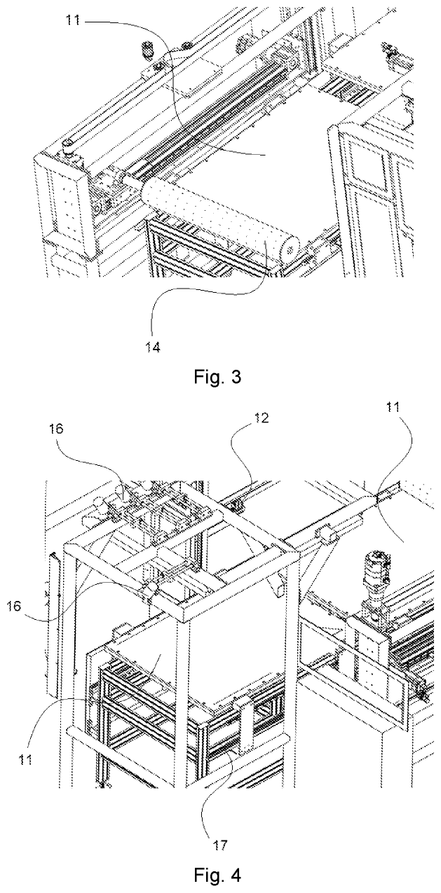

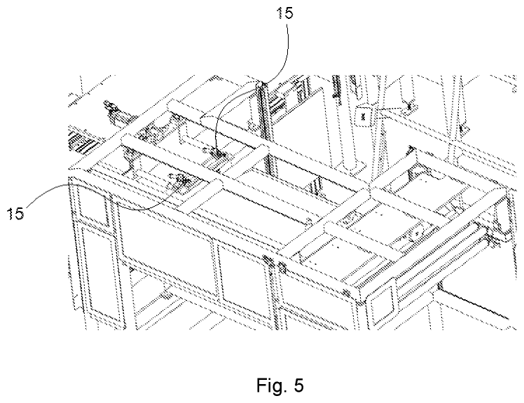

At the entrance of the apparel machine (10) shown in FIG. 2, two movable tables (11) that move independently from each other on the rail system (17) and where the raw material is placed are positioned. The rail system (17) located at the lower section of the movable table (11) moves the movable table (11). There is a camera (12) that controls the position of the raw material placed on the movable table (11) on the upper section of said movable tables (11). The movable winding mandrel (14) that is located at the end section of said movable table (11) and is shown in FIG. 3, moves up-down and forward-backward on the movable table (11) by means of a servo motor. A heater is placed in said movable winding mandrel (14) so as to facilitate winding of the products and an air connection where air is blown after the winding process is completed so as to facilitate removing the rubber from the movable winding mandrel (14) is made. An alignment laser (16) that is positioned on the same plane with the camera (12) shown in FIG. 4 and on the upper section of the movable table (11), shows the positions for each process step separately by positioning the raw material located on the movable table (11). The automatic cutting bench grippers (15) that are shown in FIG. 5 are positioned on the automatic rubber cutting bench (13) such that they are perpendicular to the axis of the movable tables (11) in the section where the movable winding mandrel (14) is located. Said automatic cutting bench grippers (15) enable the adjustment of the lengths of the cut raw material. Said automatic rubber cutting bench (13) cuts the raw material at the right dimensions and angles on the formula entered by means of the servo motor and blades added thereon.

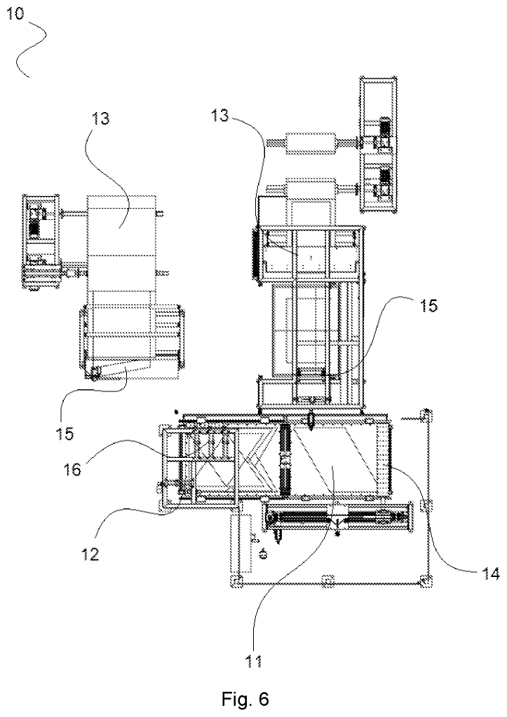

The lengths and angles of the raw material (production adjustment formulas) required for the finished product are saved in the apparel machine (10) system that is shown in FIG. 6. The determined dimensions are cut automatically by means of a blade on the automatic rubber cutting bench (13). The automatic cutting bench grippers (15) enable to adjust length and prepare the raw material and the raw material is made ready for the winding process. The cut raw material is taken respectively by the operator and placed on the moving table (11) in the proper position. When positioning is performed on the movable table (11), the positions shown separately for each operation by the alignment lasers (16) are considered. After the raw material is positioned in the correct position, the start button is pressed to continue the process. Meanwhile, the position control of the raw material located with the camera (12) is carried out. If the position is wrong, the apparel machine (10) does not operate and gives a warning, if it is correct, the process continues. While the movable table (11) that has the raw material thereon moves towards the front side on the rail system (17) for the winding process, the other empty movable table (11) returns to the front of the operator. Meanwhile, the operator takes the next cut raw material from the automatic rubber cutting bench (13). In case the movable table (11) which does not have raw material thereon comes in front of the operator, the operator repeats the steps of the former movable table (11). In case the movable table (11) on which the raw material is located comes to the front part for the winding process, the movable winding mandrel (14) comes to the appropriate position on the movable table (11). The movable table (11) and the movable winding mandrel (14) are positioned relative to each other on the vertical axis. The movable mandrel (14) rotates and moves forwardly and the raw material is wound on the winding mandrel (14) from the movable table (11). After the operator gives approval by placing the raw material on the movable table (11) without raw material on it, the movable tables (11) change position and the winding process is repeated. The wound membrane on the winding mandrel (14) is removed after the raw material layers that constitute the final product are completed.

1. An automatic apparel machine used in the manufacture of air suspension springs, the apparel machine comprising:
two movable tables that move independently from each other on a rail system and where raw material is placed;
a movable winding mandrel moving up-down and forward-backward on the movable table by means of a servo motor;
automatic cutting bench grippers that are positioned on an automatic rubber cutting bench perpendicular to an axis of the movable tables in a section where the moving winding mandrel is located so as to adjust lengths of cut raw material; and
wherein the automatic rubber cutting bench cuts the raw material in the direction of the length and angles required for the finished product saved in the system.

2. Apparel machine according to claim 1, comprising, a rail system that is located at a lower section so as to move the movable table.

3. Apparel machine according to claim 1, comprising, a camera that is positioned on an upper section of the movable tables so as to control the position of the raw material placed on the movable table.

4. Apparel machine according to claim 1, comprising, an alignment laser that shows positions for each process step separately by positioning the raw material located on the movable table, is positioned on the same plane with the camera and on an upper part of the movable table.

5. Apparel machine according to claim 1, comprising, servo motors and blades that are positioned on the automatic rubber cutting bench so as to cut the raw material at the right dimensions and angles on the formula entered.

6. Apparel machine according to claim 1, comprising, a servo motor that provided the rotation drive of the movable winding mandrel so as to prevent crumpling that occur during product winding.

7. Apparel machine according to claim 1, comprising, a heater located inside the movable winding mandrel so as to facilitate the winding of the products.

8. Apparel machine according to claim 1, comprising, an air connection where air is blown after the winding process is completed so as to facilitate removing the rubber from the movable winding mandrel and made into the movable winding mandrel.
